(19) United States
(12) Patent Application Publication
(10) Pub. No.: US 2016/0217113 A1
(43) Pub. Date: Jul. 28, 2016

(54) DEPENDENCY-SENSITIVE SYLLABUS EDITOR

(71) Applicant: Carnegie Learning, Inc., Pittsburgh, PA (US)

(72) Inventors: Sandra Bartle, Jefferson Hills, PA (US); David Dengler, Pittsburgh, PA (US); Robert Hausmann, Swissvale, PA (US); Kristine Petsche, Pittsburgh, PA (US)

(21) Appl. No.: 14/606,984

(22) Filed: Jan. 27, 2015

(51) Int. Cl. G06F 17/24; G06F 17/27; G06F 3/0482; G09B 5/00; G06F 3/0484

(52) U.S. Cl. CPC G06F 17/24; G09B 5/00; G06F 3/0484; G06F 3/0482; G06F 17/2765

(57) ABSTRACT

A syllabus editing system is described hereafter for editing a course syllabus. The syllabus editing system aids the user in adjusting what learning objects are included in a syllabus. The system further checks dependency violations in an edited syllabus, where a dependency violation occurs when fundamental concepts for a particular learning object are not presented prior to the particular learning object within the flow of the syllabus. Embodiments provide information about detected dependency violations, information about learning objects that may be used to correct the dependency violations, and information helpful in aiding a user in editing the syllabus intelligently. Furthermore, embodiments provide an option to automatically correct dependency violations. Such an automatic correction involves identifying one or more solutions to the dependency violation. According to an embodiment, a solution that represents a minimum change to the syllabus is automatically identified and implemented in order to correct a detected dependency violation.

### CROSS-REFERENCE TO RELATED APPLICATIONS

This application is related to application Ser. No. 13/______,______, titled “Teaching Recommendation System” (attorney docket number 60201-0439), filed ______ ______, ______.

### FIELD OF THE INVENTION

The present invention relates to a system for editing a course syllabus, and, more specifically, to a system that facilitates intelligent editing of a course syllabus, including automatically identifying and automatically correcting learning object dependency violations in an edited syllabus.

### BACKGROUND

The syllabus for an educational course indicates which educational material will be presented for the course, and an order in which educational material will be presented. Many times, certain topics are difficult to properly understand when the learner does not already understand one or more fundamental concepts relating to the certain topics. It is said that these certain topics “depend on” the fundamental concepts because understanding of the certain topics depends on prior understanding of the fundamental concepts. For example, it is difficult to understand basic algebra without an understanding of basic arithmetic.

There are many situations in which the teacher of a particular educational course needs to create or edit a syllabus for the course. For example, the teacher may be preparing to teach the course for the first time, may need to arrange the course to conform to changing teaching standards or changing requirements for the course, may run out of time to teach all of the remaining concepts of the course in the allotted time, etc.

As a teacher creates or modifies a syllabus, it is difficult for the teacher to keep in mind all dependencies between all topics that the teacher may decide to include in the syllabus. If the teacher does not have in mind all such dependencies at the time of syllabus creation or modification, then it is possible for the teacher to establish a syllabus in which a topic is scheduled to be taught without first teaching other topics upon which it depends. Such dependency violations within the syllabus may lead to student confusion and a less-than-optimal learning experience.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for providing a syllabus editor that checks learning object dependencies in connection with authoring/editing of a syllabus.

FIG. 2 depicts a flowchart for identifying dependency violations in an edited syllabus.

FIGS. 3A-3E depict example graphical user interfaces for editing a syllabus and providing dependency information to a user.

FIGS. 4A-4D depict example graphical user interfaces for editing a syllabus.

FIG. 5 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, structures and devices are shown in block diagram form in order to avoid unnecessarily obscuring the present invention.

### GENERAL OVERVIEW

A syllabus editing system is described hereafter which facilitates intelligent editing of a course syllabus without violating dependencies between topics and without having to memorize all such dependencies. The syllabus editing system aids the user in adjusting what topics, as embodied in learning objects, are included in a syllabus. The system further automatically checks dependency violations in an edited syllabus, where a dependency violation occurs when fundamental concepts for a particular learning object in the syllabus are not presented prior to the particular learning object within the flow of the syllabus.

Embodiments of the system provide information about detected dependency violations, information about learning objects that may be used to correct the dependency violations, and also other information helpful in aiding a user in producing an edited syllabus that is free of dependency violations.

Furthermore, embodiments of the system provide an option to automatically correct dependency violations found in a syllabus. Such an automatic correction involves identifying one or more solutions to a dependency violation. According to an embodiment, a solution that represents a minimum change to the syllabus is automatically identified and implemented in the syllabus to correct the detected dependency violation.

### Syllabus Editor Architecture

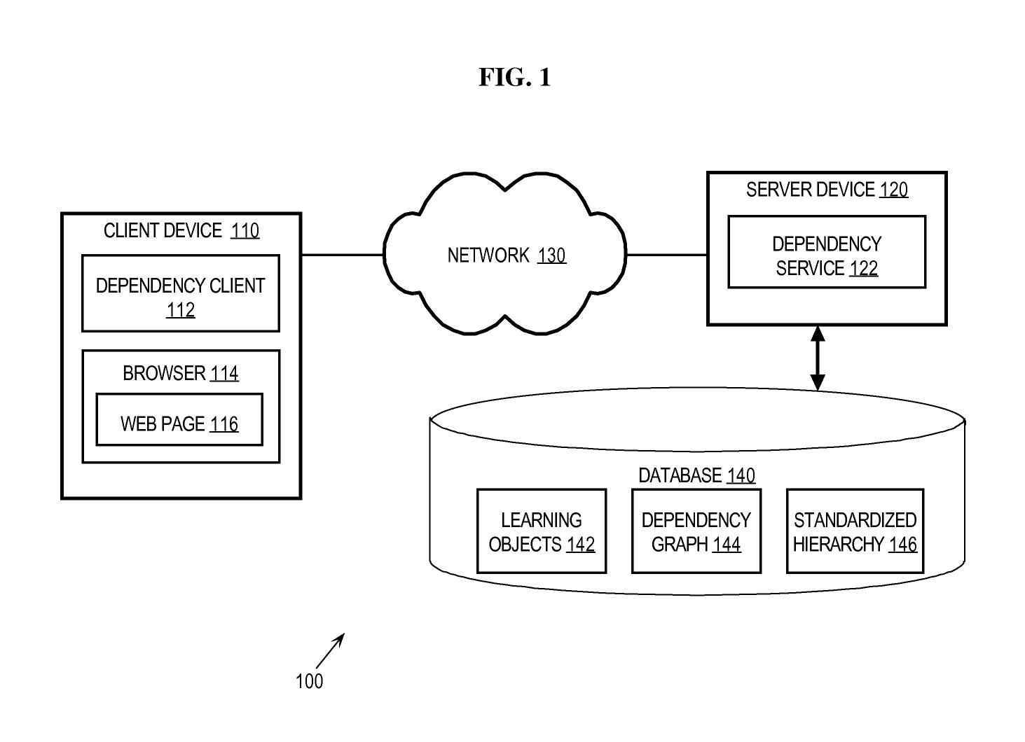

Techniques are described hereafter for checking learning object dependencies in an edited syllabus. FIG. 1 is a block diagram that depicts an example network arrangement 100 for providing a syllabus editor that checks learning object dependencies in connection with authoring/editing a syllabus, according to embodiments. Network arrangement 100 includes a client device 110 and a server device 120 that are communicatively coupled via a network 130. Server device 120 is also communicatively coupled to a database 140. Example network arrangement 100 may include other devices, including client devices, server devices, and display devices, according to embodiments. For example, one or more of the services attributed to server device 120 herein may run on other server devices that are communicatively coupled to network 130.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, video game consoles, and any other type of computing device.

In network arrangement 100, client device 110 is configured with a dependency client 112 and a browser 114 that displays a web page 116. Client device 110 may be configured with other mechanisms, processes and functionalities, depending upon a particular implementation.

Dependency client 112 may be implemented in any number of ways, including as a plug-in to browser 114, as an application running in connection with web page 116, as a stand-alone application running on client device 110, etc. Dependency client 112 may be implemented by one or more logical modules, and is described in further detail below. Browser 114 is configured to interpret and display web pages that are received over network 130 (e.g., web page 116), such as Hyper Text Markup Language (HTML) pages, and eXtensible Markup Language (XML) pages, etc.

Further, client device 110 is communicatively coupled to a display device (not shown in FIG. 1), for displaying graphical user interfaces, such as graphical user interfaces of web page 116. Such a display device may be implemented by any type of device capable of displaying a graphical user interface. Example implementations of a display device include a monitor, a screen, a touch screen, a projector, a light display, a display of a tablet computer, a display of a telephony device, a television, etc.

To illustrate display of a particular GUI, dependency client 112 on client device 110 receives information for a web page 116, which includes a particular GUI (such as any GUI described herein), from dependency service 122 of server device 120. Browser 114 of client device 110 interprets the information for web page 116 and displays, via a display device, the particular GUI. As a further illustration, dependency client 112 displays, via a display device, the GUIs described herein as a stand-alone application. In this illustration, dependency client 112 receives any needed information for a particular GUI from dependency service 122 and displays the information in the GUI.

Network 130 may be implemented with any type of medium and/or mechanism that facilitates the exchange of information between client device 110 and server device 120. Furthermore, network 130 may facilitate use of any type of communications protocol, and may be secured or unsecured, depending upon the requirements of a particular embodiment.

Server device 120 may be implemented by any type of computing device that is capable of communicating with a client device over network 130. In network arrangement 100, server device 120 is configured with dependency service 122. Dependency service 122 may be part of a cloud computing service, and also may be implemented by one or more logical modules. Server device 120 may be configured with other mechanisms, processes and functionalities, depending upon a particular implementation.

Server device 120 is communicatively coupled to a database 140. Database 140 maintains one or more of learning objects 142, dependency graph 144, and standardized hierarchy 146. According to embodiments, any of learning objects 142, dependency graph 144, and standardized hierarchy 146 resides in memory other than memory associated with database 140, where dependency service 122 can access the memory via network 130. Database 140 may reside in any type of storage, including volatile and non-volatile storage (e.g., random access memory (RAM), a removable or disk drive, main memory, etc.), and may be implemented by one or more logical databases. The storage on which database 140 resides may be external or internal to server device 120.

Either of dependency client 112 and dependency service 122 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from the other entity. Further, either of dependency client 112 and dependency service 122 may send one or more such communications over network 130, e.g., to one of the other entities of the system.

Functionality attributed to one or more of dependency service 122 and dependency client 112 may be performed by a different service/client, such as the other dependency service 122 and dependency client 112, according to embodiments. In an embodiment, each of the processes described in connection with one or more of dependency client 112 and dependency service 122 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Learning Objects

Learning objects 142 include any kind of information that may be assigned to syllabi, such as one or more of: chapters, lessons, learning activities, assessments, etc. As used herein, the terms “chapter”, “lesson”, “learning activity”, and “assessment” generally refer to learning objects of various degrees of specificity, and are not limited to any particular definition beyond those applicable definitions provided herein. Each learning object embodies a topic and is configured to teach or assess one or more concepts. For example, a chapter includes many details relating to a particular concept or multiple related concepts (e.g., “Ratios”, “Algebraic Equations”, etc.).

A chapter is generally comprised of lessons, which include less information than a chapter. More specifically, a lesson is usually focused on a particular aspect of the one or more general concepts covered by a chapter. For example, a particular lesson in a chapter on ratios focuses on a particular aspect of ratios. Example lessons in a chapter on ratios cover the definition of a ratio, ratio terminology, simplifying ratios, etc.

A _{[SB1]}topic includes lessons which then include one or more learning activities, where a learning activity is an electronic activity that is configured to help a student learn one or more concepts and/or skills that are generally related to the subject matter taught by the chapter or lesson of which the learning activity is a part. A learning activity may be an interactive application, a portion of text, a video, audio content, a worksheet, etc. For example, the “Ratio” chapter includes a lesson on simplifying ratios, which in turn includes a video-type learning activity in which a video demonstrates how to simplify a ratio.

Assessments test a student's knowledge of particular concepts and/or skills An assessment may cover any breadth of subject matter. As such, a particular assessment may test a student's knowledge of subject matter presented in one or more learning objects, one or more lessons, one or more chapters, etc.

Data for a particular learning object of learning objects 142 in database 140 includes metadata for the learning object. Metadata for a learning object includes one or more of: title; author; link(s) to one or more component learning objects (such as lessons for a chapter-type learning object); a standard term associated with the learning object (such as the name of a standardized concept that is a counterpart to the learning object, or the name of a standardized concept introduced in the learning object, etc.); a reference to a secondary concept hierarchy (such as a reference to an object located in standardized hierarchy 146 stored at database 140); key terms describing one or more concepts taught by the learning object; key terms describing one or more concepts on which the learning object depends; one or more references to other learning objects 142 on which the learning object depends; etc.

According to an embodiment, a particular learning object of learning objects 142 includes a reference to a secondary concept hierarchy, such as standardized hierarchy 146. A secondary concept hierarchy defines dependency links between entities (such as key terms, learning objects, etc.) other than learning objects 142. To illustrate, standardized hierarchy 146 represents dependency links between key terms from a standardized curriculum. An example of a standardized curriculum is the Common Core standard, though embodiments are not limited to a particular standardized curriculum.

As a further example, a particular chapter-type learning object from learning objects 142, called “Ratios”, includes a metadata reference to a standardized concept “Ratios and Proportional Relationships” in standardized hierarchy 146. The reference indicates a relationship between the learning object and the concept in standardized hierarchy 146. For example, the learning object teaches the skills and principles represented by the standardized concept.

### Dependency Graph

Dependency graph 144 represents dependencies between learning objects 142. Information in dependency graph 144 that indicates a dependency relationship between a first learning object and a second learning object is herein called a “dependency link”. As such a dependency link represents information about (a) one or more fundamental concepts or learning objects, and (b) one or more dependent learning objects or concepts (called “dependent” because the learning objects or concepts depend on the fundamental concepts or learning objects). Dependency links may be represented in dependency graph 144 in any manner within embodiments. Further, according to embodiments, dependency links may include information (such as metadata) about the nature of the dependency (e.g., information about why a dependent learning object depends on a fundamental learning object, etc.).

Dependency graph 144 may store dependency links between different types of learning objects. For example, a particular chapter-type learning object may depend on one or more lesson-type learning objects.

Furthermore, dependency graph 144 may store dependency links between learning objects in different areas of learning (such as from different courses, different disciplines, different colleges within a university, etc.). Such dependency links allow for flexibility in identifying dependencies for a learning object, e.g., that is being pulled into a course syllabus from a different course.

Dependencies between learning objects 142 represented in dependency graph 144 may be established in any number of ways within embodiments. According to an embodiment, administrators establish dependency links in dependency graph 144. For example, an administrator provides dependency service 122 with information indicating that a first learning object (“Algebraic Expressions”) is dependent on a second learning object (“Introduction to Expressions”). In response to receiving this information, dependency service 122 saves a dependency link that represents the relationship between the two learning objects in dependency graph 144.

According to another embodiment, dependency service 122 automatically derives dependency links in dependency graph 144. Dependency service 122 automatically derives dependency links using a variety of techniques.

Automatically-derived dependency links may be also automatically flagged for administrator review. When flagged, a dependency link is not used to determine dependencies. When an administrator clears the flag, dependency service 122 treats the previously-flagged dependency link as any other dependency link. Such a review process allows greater flexibility in automatically deriving dependency links.

According to embodiments, dependency service 122 dynamically derives dependency links from information for learning objects 142 and/or information within dependency graph 144. For example, dependency service 122 derives dependency links based on the transitive property of dependency links. For example, if learning object A depends on learning object B and learning object B depends on learning object C, then learning object A also depends on learning object C.

According to embodiments, upon detecting a circular dependency represented by two or more dependency links (e.g., learning object A depends on learning object B and learning object B depends on learning object A), dependency service 122 automatically flags the two or more dependency links for review.

### KEY TERMS

According to embodiments, dependency service derives dependency links based on key terms in metadata of learning objects 142. In these embodiments, one or more learning objects in learning objects 142 include, in metadata, key terms that describe concepts associated with the learning objects. A concept associated with a learning object is one or more of: a concept being taught by the learning object, a concept required for understanding the learning object, a concept that describes a skill taught by the learning object, etc. In embodiments, the key terms comprise standardized terms from standardized hierarchy 146. A particular learning object (such as a chapter) is associated with all key terms for all component learning objects (such as from the lessons of a chapter).

To automatically derive a dependency from key terms, dependency service 122 identifies a definitional use of a key term. Administrators specify, in learning object metadata, that a particular learning object associated with a particular key term has a definitional use of the key term when the learning object includes an introduction or definition for the concept described by the key term. For example, an administrator (such as the author of a learning object) specifies, in the metadata for a particular learning object (“Chapter A”), that the learning object includes definitional uses of one or more key terms.

According to embodiments, dependency service 122 automatically scans learning objects 142 to automatically derive potential new dependency links. In connection with such a scan, dependency service 122 identifies a learning object with a definitional use of a particular key term (such as Chapter A). Dependency service 122 further identifies one or more other learning objects that are also associated with the particular key term. In response to these identifications, dependency service 122 derives one or more dependency links, where each of the derived dependency links is between the learning object with the definitional use of the key term (as the fundamental object) and a particular learning object of the one or more learning objects that are associated with the same key term (as a dependent object).

In an embodiment, a dependency link of dependency graph 144 is associated with metadata that describes the link, e.g., a type of the link. To illustrate in the context of the example above, dependency service 122 associates, with each dependency link derived based on definitional uses of key terms, dependency link metadata that indicates that the dependency link is a definitional dependency.

According to embodiments, dependency service 122 also automatically identifies definitional uses of key terms in learning object metadata based on non-flagged dependency links in dependency graph 144. Specifically, dependency service 122 identifies a root fundamental object in dependency graph 144, where a root fundamental object is a learning object that does not depend on other learning objects in the graph. Dependency service 122 provisionally identifies any key terms associated with the root fundamental object as definitional uses. Once an administrator verifies that one or more of the key terms associated with the root fundamental object are definitional uses of those key terms, dependency service 122 derives dependency links between the root fundamental object and other learning objects in database 140 that (a) are associated with at least one of the identified key terms in metadata, and (b) are not root fundamental objects.

According to embodiments, dependency graph 144 uses key terms as fundamental objects and dependent objects in dependency graph 144. To illustrate, dependency graph 144 includes a dependency link indicating that the key term “Pythagorean theorem” is a dependent key term that depends on the fundamental key term “algebraic variables” and also on the fundamental key term “exponents”. Dependency graph 144 includes another dependency link that indicates that the key term “algebraic variables” is a dependent key term that depends on the fundamental key term “basic arithmetic”.

Based on such key term dependency links, dependency service 122 automatically derives dependencies between learning objects 142. Specifically, dependency service 122 derives a dependency link where a learning object associated with a particular fundamental key term becomes a fundamental learning object for a second learning object that is associated with a dependent key term (that depends on the particular fundamental key term in dependency graph 144). For example, dependency service 122 automatically determines that a first learning object associated with the key term “Pythagorean theorem” depends on a second learning object associated with the key term “algebraic variables” and automatically derives a dependency link between the two learning objects.

According to embodiments, dependency links may also be established between key terms and learning objects. To illustrate, an administrator indicates, to dependency service 122, that a particular learning object depends on one or more fundamental key terms. In response to receiving this information, dependency service 122 saves one or more dependency links in dependency graph 144 that represent the relationships between the one or more fundamental concepts and the dependent learning object. In an embodiment, dependency service 122 represents relationships between fundamental key terms and dependent learning objects in metadata for the learning object, where the metadata for each dependent learning object includes an indication that the learning object depends on one or more fundamental key terms.

Dependency service 122 derives additional dependency links from dependency links between key terms and learning objects. For example, dependency graph 144 includes a non-flagged dependency link indicating that a first learning object (“Algebraic Expressions”) is dependent on the key term “expressions”. Dependency service 122 further determines that a second learning object (“Introduction to Expressions”) includes a definitional use of the key term “expressions”. Dependency service 122 derives a dependency link between the two learning objects with the first learning object (“Algebraic Expressions”) as the dependent learning object and the second learning object (“Introduction to Expressions”) as the fundamental learning object.

### Standardized Hierarchy

According to embodiments, dependency service 122 also infers dependency links based on standardized hierarchy 146. To illustrate, dependency service 122 identifies a reference, in the metadata of a particular learning object titled “Ratios”, to the standardized key term “Ratios and Proportional Relationships” in standardized hierarchy 146. A standardized key term is a key term that is included in standardized hierarchy 146. Dependency service 122 identifies one or more dependency links in standardized hierarchy 146 with the key term “Ratios and Proportional Relationships” as the dependent standardized key term, and where the identified dependency links indicate one or more fundamental standardized key terms for “Ratios and Proportional Relationships”. Dependency service 122 further identifies one or more learning objects (of learning objects 142) that are associated, in metadata, with the one or more fundamental standardized key terms for the concept “Ratios and Proportional Relationships”. In response to identifying these one or more learning objects, dependency service 122 infers dependency links between the one or more learning objects as fundamental learning objects and the object “Ratios” as the dependent learning object.

### Editing a Syllabus

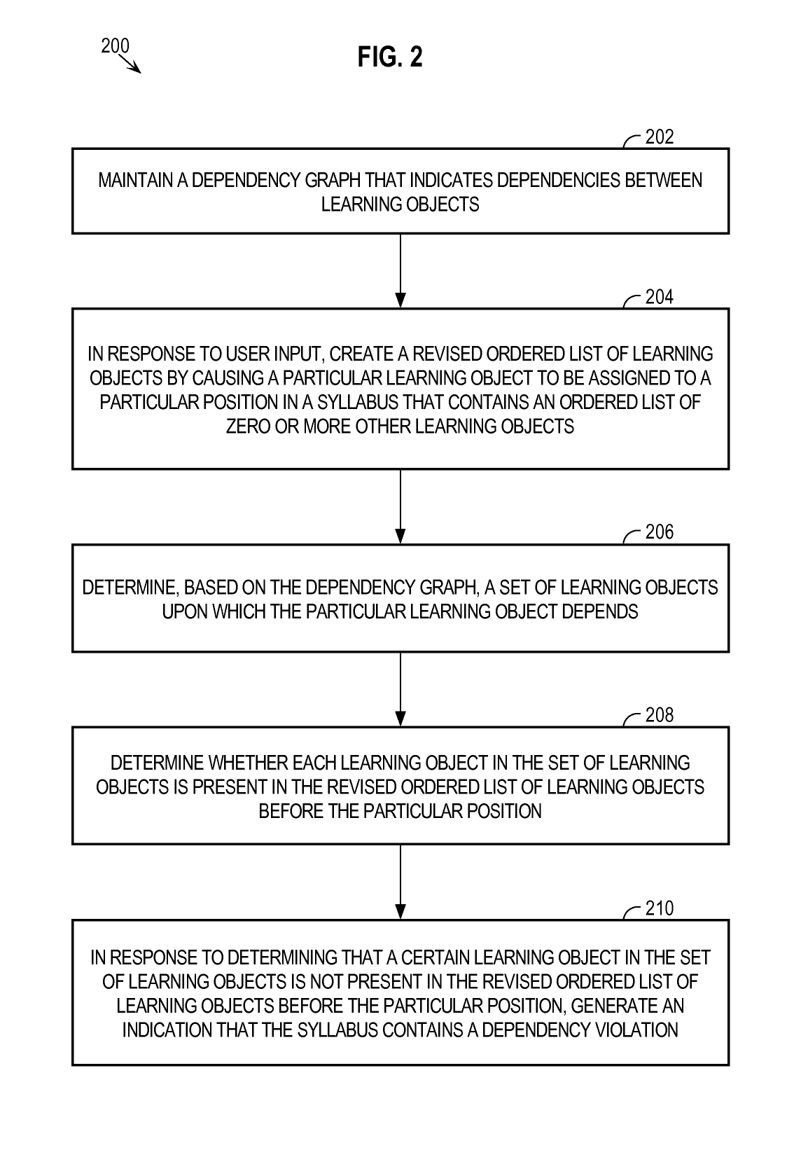

FIG. 2 depicts a flowchart 200 for identifying dependency violations in an edited syllabus. At step 202, a dependency graph that indicates dependencies between learning objects is maintained. For example, dependency service 122 maintains dependency graph 144 in database 140. Dependency graph 144 includes information about dependencies between learning objects of learning objects 142.

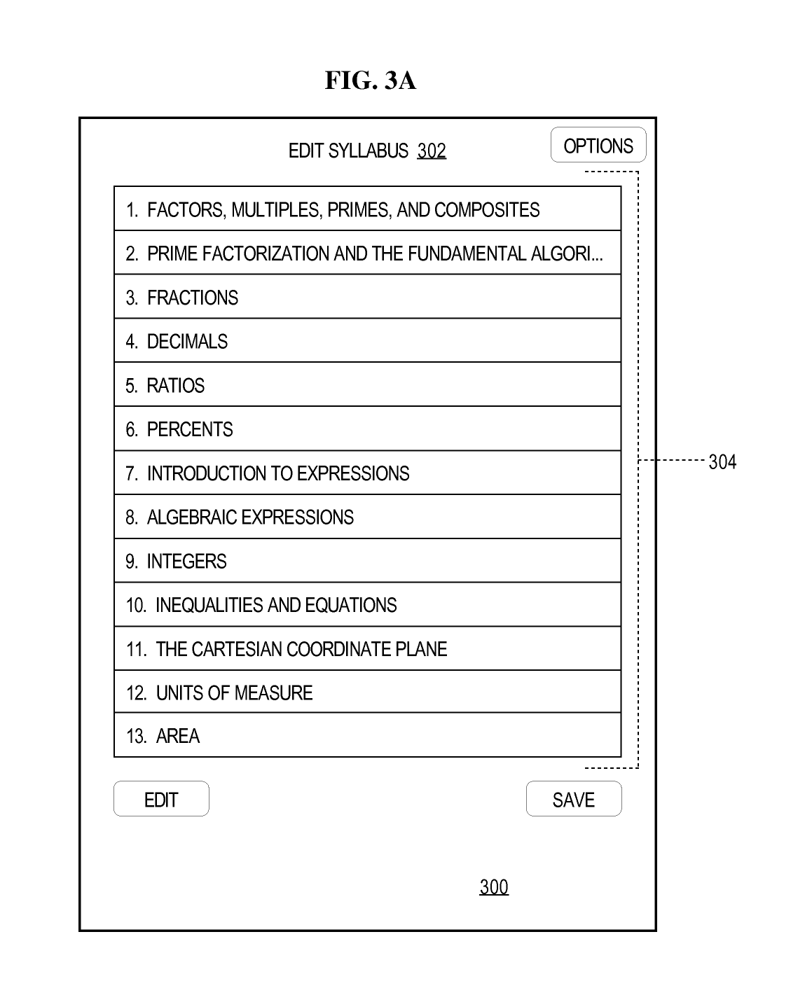

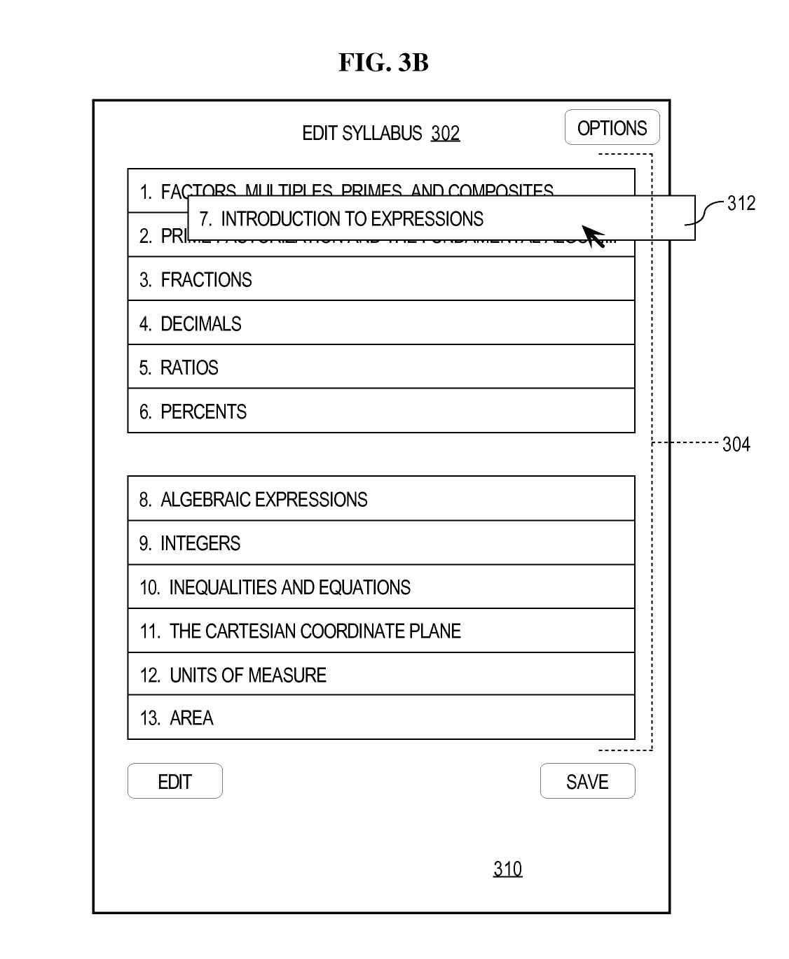

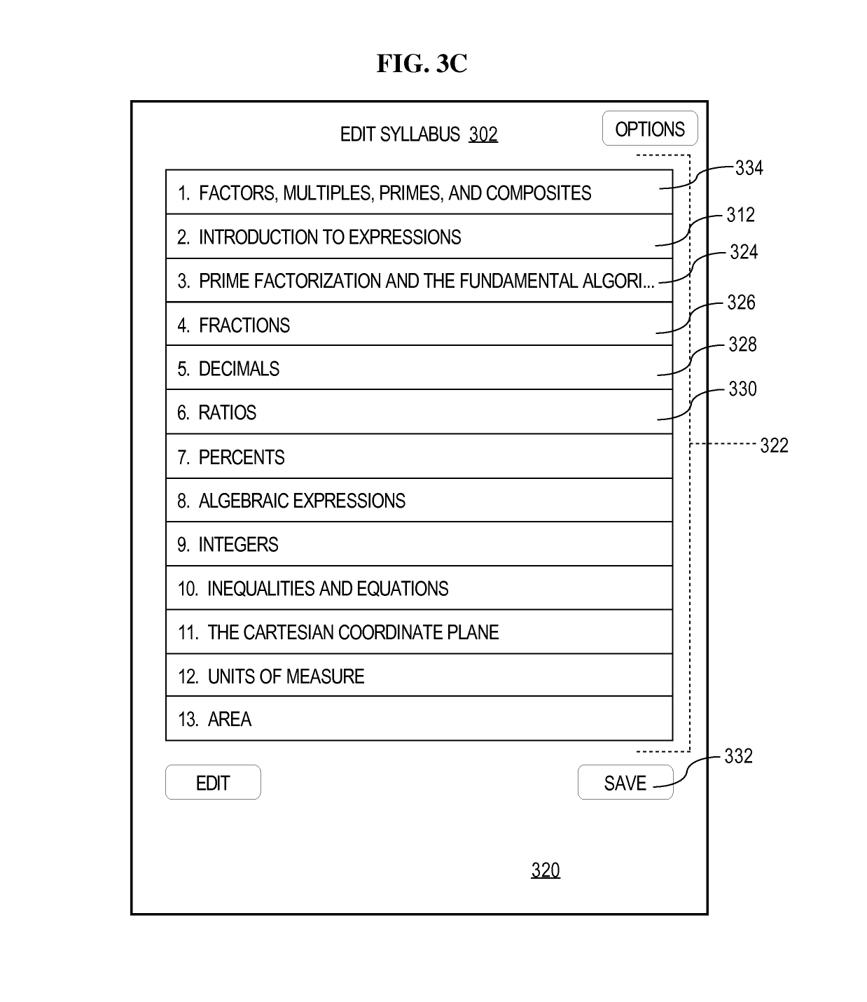

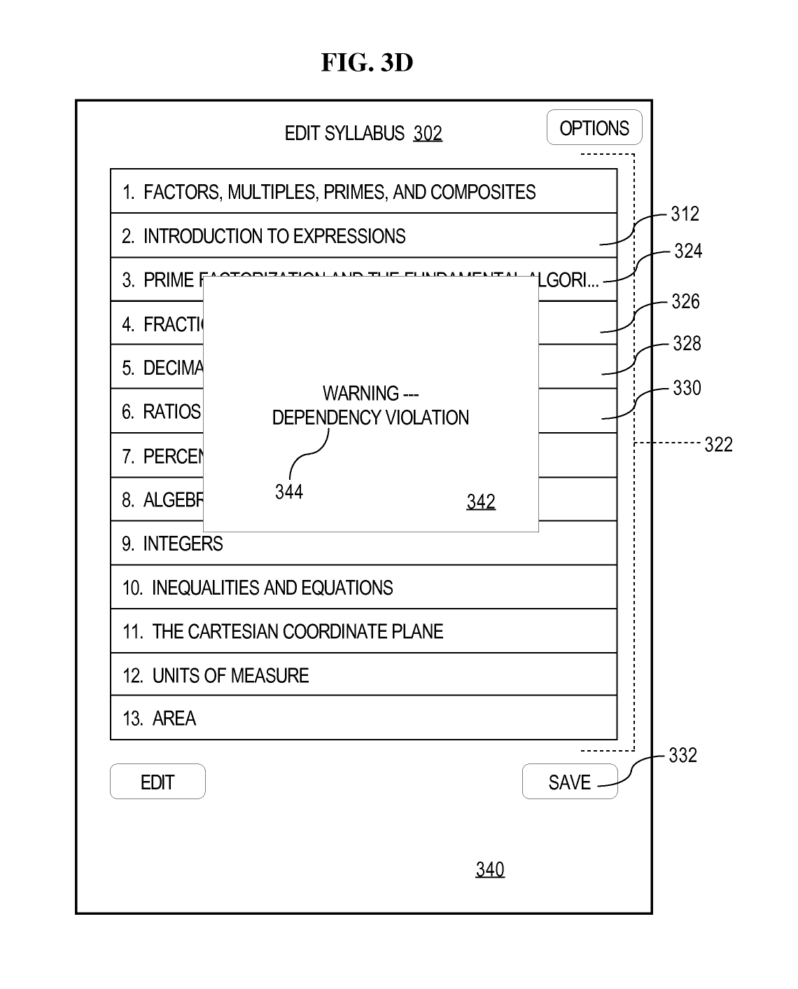

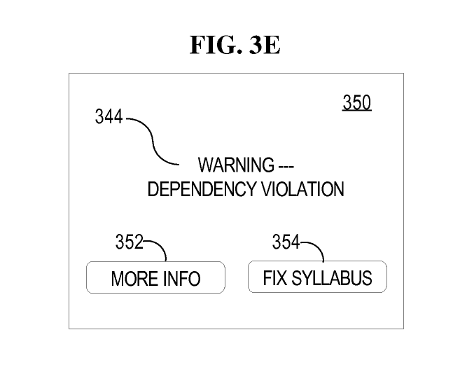

At step 204, in response to user input, a revised ordered list of learning objects is created by causing a particular learning object to be assigned to a particular position in a syllabus that contains an ordered list of zero or more other learning objects. For example, dependency client 112 causes GUI 300 of FIG. 3A to be displayed at client device 110, where GUI 300 includes representations of learning objects, from learning objects 142, in an initial ordered list 304. The learning objects in list 304 are assigned to a syllabus 302.

GUI 300 is configured to accept a user command to place a particular learning object in a target position in ordered list 304. To illustrate, in GUI 310 of FIG. 3B a user issues a command to reorder ordered list 304, i.e., by dragging a particular learning object 312 from an initial position in list 304 to a target position in GUI 310 that represents a different position in the list than the initial position. Specifically, GUI 310 depicts a user dragging learning object 312 from the seventh position in list 304 to the second position in list 304 (i.e., between objects 1 and 2).

According to embodiments, a user may issue a command to place a particular learning object in a target position in any way that allows the user to communicate, to dependency client 112, a target position, in list 304, for the particular learning object. Such a command may cause: reordering of list 304 (as described above); a learning object not previously in list 304 to be added at a particular position in ordered list 304, e.g., as part of an initial creation of the syllabus; removal of a learning object from ordered list 304; replacement of a learning object included in list 304 with a learning object not currently in the list, etc.

In response to detecting the user command, dependency client 112 displays a reordered list in which the indicated learning object is in the target position indicated by the user and all other objects in the list are reordered accordingly. Returning to the example of FIGS. 3A-3D, dependency client 112 displays GUI 320 (FIG. 3C) depicting representations of learning objects in a revised ordered list 322 for syllabus 302, where revised ordered list 322 is based on initial ordered list 304. Specifically, in revised ordered list 322, learning object 312 is in the second position in list 322, as instructed by the user.

### Additional Graphical User Interface for Editing a Syllabus

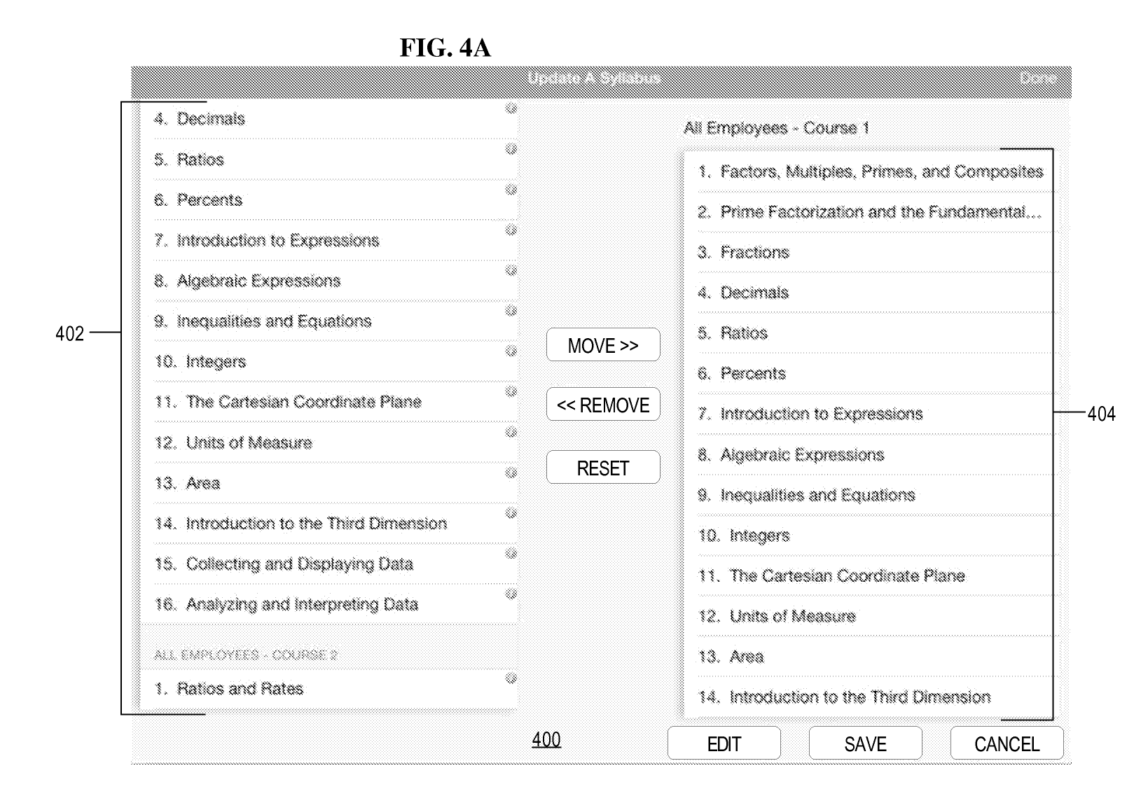

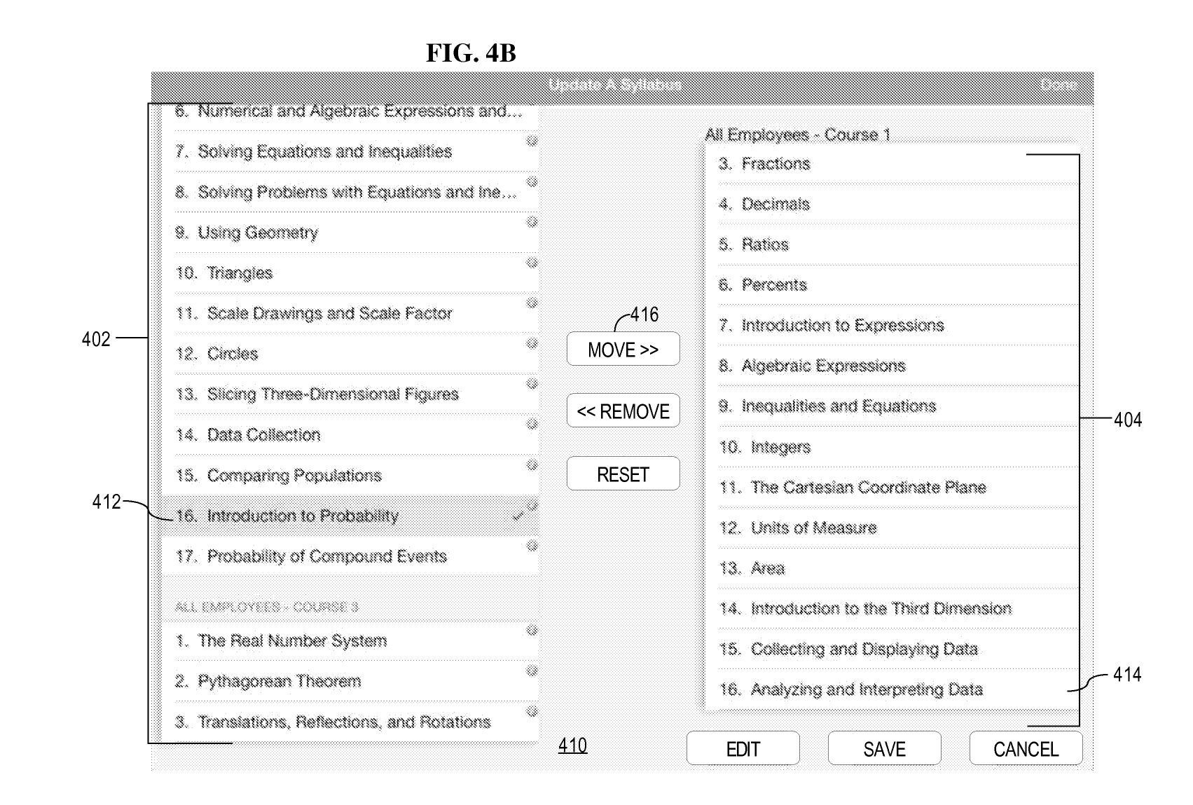

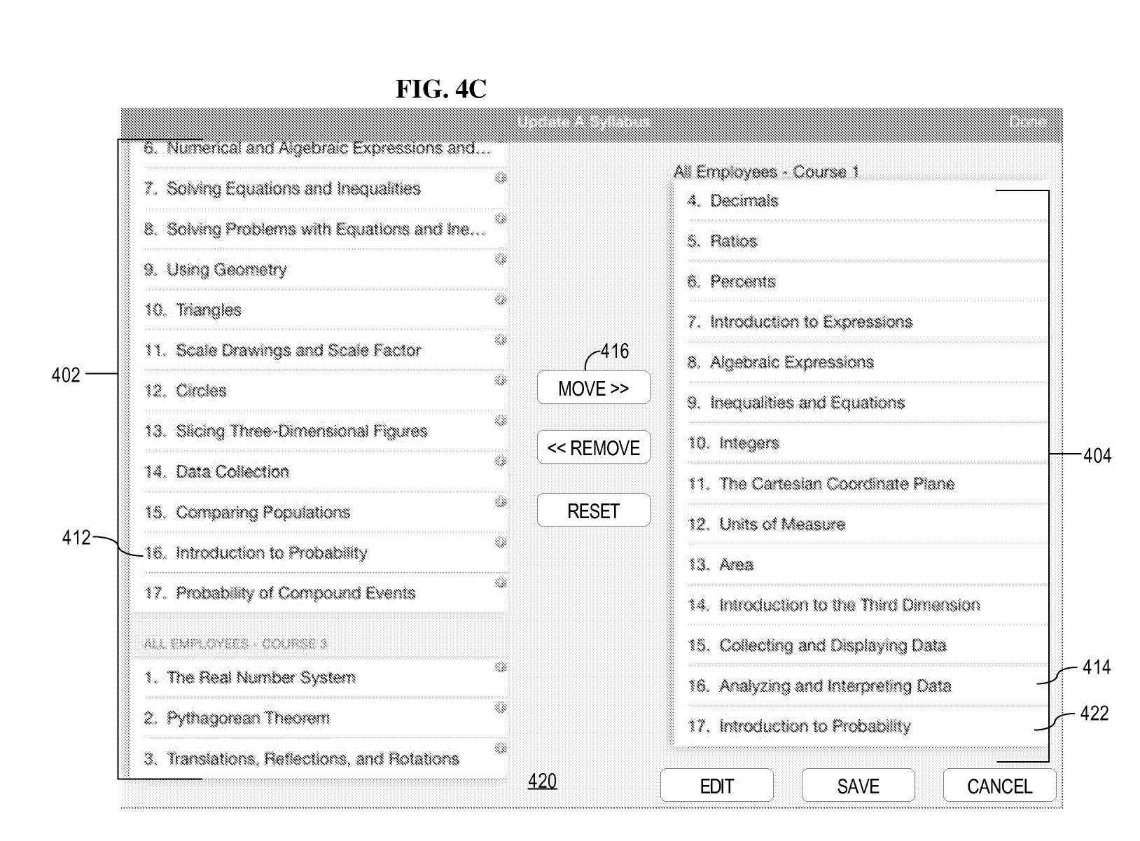

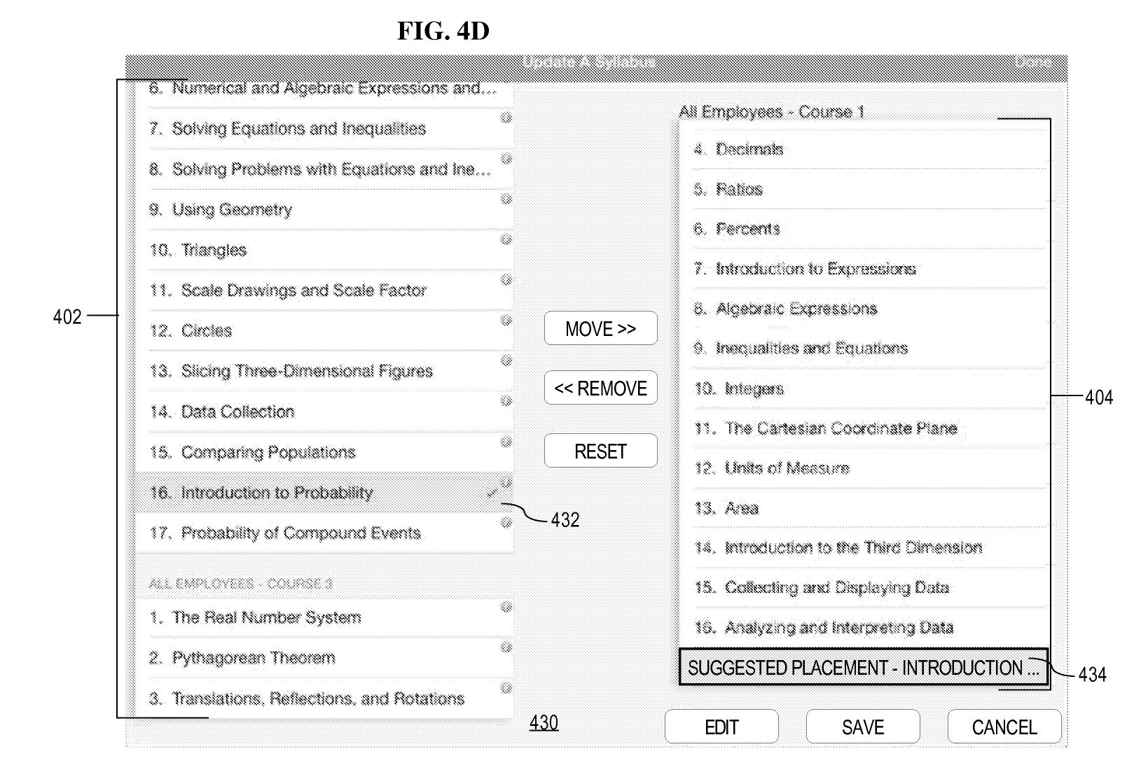

FIGS. 4A-4D depict another example graphical user interface for editing a syllabus. FIG. 4A depicts a GUI 400 in which a list of candidate learning objects 402 and a list of syllabus learning objects 404 associated with a particular course syllabus (i.e., “Course 1”) are presented. The list of candidate learning objects 402 includes learning objects that are associated with default configurations of multiple courses (including “Course 1”, “Course 2”, etc.). GUI 400 further includes controls for moving and removing learning objects to and from list 404, and controls to edit and save the syllabus, as well as a control to cancel out of the operation.

GUI 410 of FIG. 4B depicts user selection of a representation of learning object 412 from the list of candidate learning objects 402. As depicted in GUI 420 of FIG. 4C, in response to the user activating move control 416, dependency service 122 adds learning object 412 to the list of syllabus learning objects 404 in position 422, which is after learning object 414 (previously the last learning object in list 404). In the example of GUI 420, the learning object 412 is moved to the last position in the syllabus learning objects list 404 in response to the user command. However, within embodiments, learning objects may be moved to any position within a syllabus list.

One of the benefits of the two-list depiction in FIGS. 4A-D is that the user may see the default list of learning objects associated with “Course 1”, even after the user has edited the version of “Course 1” shown as list 404. Furthermore, dependency client 112 may use such a two-list depiction to communicate information to a user. For example, by graying out learning objects in the list 402, dependency client 112 may communicate to the user which learning objects may not be moved to list 404 (e.g., because the learning objects are assumed to already have been taught to students of “Course 1”, because the learning objects are already included in list 404, because a substantially similar learning objects are already in list 404, etc.).

Furthermore, dependency client 112 may communicate information about dependency violations using such a two-list depiction, e.g., by visually highlighting representations of learning objects in list 402 that would remedy dependency violations in list 404. Also, dependency client 112 may communicate information about positions in list 404 that particular learning objects from list 402 should be placed based on dependency violation information (as discussed in further detail below in connection with FIG. 4D).

### Determining Dependencies

Returning to flowchart 200 (FIG. 2), at step 206, a set of learning objects, upon which the particular learning object depends, is determined based on the dependency graph. Returning also to the example of FIGS. 3A-3E, dependency client 112 communicates information about reordered list 322 to dependency service 122, e.g., in response to detecting the user command to move learning object 312 to the target position in list 322. As a further example, dependency client 112 communicates the information to dependency service 122 in response to detecting user activation of a done control, such as save button 332 in GUI 320 of FIG. 3C. Dependency client 112 communicates this information to dependency service 122 to initiate dependency service 122 performing a check for dependency violations in list 322. Performing dependency checks after the user has activated a done control allows the user to perform editing without being interrupted by warning messages and without requiring resources to evaluate dependencies prior to the user's final syllabus draft.

In response to receiving the information, dependency service 122 detects whether there are any dependency violations caused by the change in the ordered list of learning objects for syllabus 302 by, first, determining what fundamental learning objects at least one of the learning objects in list 322 depends on. According to embodiments, dependency service 122 identifies fundamental learning objects for only the learning object that was placed in the target location in list 322. According to embodiments, dependency service 122 identifies fundamental learning objects for two or more learning objects in list 322.

For example, dependency service 122 identifies which learning objects in list 322 are affected by changes to list 322. The following cases assume that there are no learning dependency violations in syllabus 302 prior to the detected change. In the case of adding a learning object to syllabus 302, only the added learning object is screened for dependency violations. In the case of moving a learning object within syllabus 302 (as depicted in FIGS. 3A-3D), both the learning object that was moved (i.e., learning object 312) and all learning objects in positions within syllabus 302 between the previous position and target position of the moved learning object (i.e., learning objects 324-330) are screened for dependency violations. In the case of removing a particular learning object from syllabus 302, all learning objects that followed the pre-removal position of the removed object in syllabus 302 are screened for dependency violations.

According to an embodiment, to determine a set of learning objects upon which learning object 312 depends, dependency service 122 queries dependency graph 144 to determine all dependency links that include learning object 312 as a dependent learning object. The set of learning objects that are fundamental learning objects indicated in those dependency links are the set of learning objects upon which learning object 312 depends.

In an embodiment, dependency service 122 identifies two or more learning objects, in the set of learning objects that are fundamental learning objects for learning object 312, that both have definitional uses of key terms that are also in metadata for the learning object 312. Dependency service 122 presents information for each of the two or more learning objects to a user via a graphical user interface. The user selects which learning object is considered to be a fundamental learning object for learning object 312. In this manner, the user may influence how dependency service 122 automatically corrects the dependency violations as described in further detail below.

According to embodiments, dependency service 122 adjusts the identified set of learning objects upon which learning object 312 depends based on information for syllabus 302. For example, database 140 includes metadata for syllabus 302 that indicates one or more key terms describing concepts that students of syllabus 302 are assumed to understand prior to undertaking the course. For example, metadata for syllabus 302 indicates that basic arithmetic skills are assumed to be mastered by people entering the course associated with syllabus 302. Based on this information, dependency service 122 removes, from the identified set of fundamental learning objects upon which learning object 312 depends, those learning objects that teach basic arithmetic skills as indicated in key terms in metadata for those learning objects.

Furthermore, dependency service 122 may have access information about the students undertaking the course associated with syllabus 302 (e.g., student profiles). A student profile is a record of information pertinent to a particular student, and includes information such as: courses taken, course grades achieved, background, age, sex, proficiencies, etc. If information for the students indicates that the students of syllabus 302 have all mastered basic arithmetic skills, then dependency service 122 removes, from the identified set of fundamental learning objects upon which learning object 312 depends, learning objects that teach basic arithmetic skills.

Continuing with the example of GUI 320, dependency service 122 determines that learning object 312 depends from learning object 330.

At step 208, it is determined whether each learning object in the set of learning objects is present in the revised ordered list of learning objects before the particular position. For example, dependency service 122 determines whether the learning objects on which learning object 312 depends (i.e., learning object 330) is located before learning object 312 in ordered list 322. In the example of GUI 320, learning object 330 is located after learning object 312, and not before it, in list 322. As such, learning object 312 is subject to a dependency violation because not all of the fundamental concepts for learning object 312 are taught by learning objects positioned before learning object 312 in the ordered list of learning objects for syllabus 302. According to embodiments, a dependency violation is identified when any one or more of the learning objects in a set of fundamental learning objects on which a particular learning object depends is not positioned before the particular learning object in a syllabus.

At step 210, in response to determining that a certain learning object in the set of learning objects is not present in the revised ordered list of learning objects before the particular position, an indication that the syllabus contains a dependency violation is generated. For example, dependency service 122 causes dependency client 112 to display a warning indicator, such as warning window 342 of GUI 340 (FIG. 3D). In the example of GUI 340, warning window 342 is a pop-up window. Warning window 342 includes a warning message 344 that, in this example, is a generic warning message that only indicates that a dependency violation was found. According to embodiments, a warning window such as warning window 342 includes an ignore control that, when activated, dismisses the window without requiring further action.

As another example, a warning window (such as warning window 342) is displayed as a GUI panel that is shown simultaneously with syllabus editing controls. Such a warning window panel does not cover any controls for syllabus editing and, as such, does not interrupt the flow of editing. Thus, dependency client 112 may display warning messages in a warning window panel as the user is editing in real time as dependency violations occur (and are detected). In this embodiment, dependency service 122 checks for dependency violations when changes are made to syllabus 302, and not just when syllabus 302 is saved.

### Warning Message Content

According to embodiments, a warning message presented by dependency client 112 (e.g., via warning window 342 or in other ways) includes information and/or controls that aid a user in correcting dependency violations. In these embodiments, dependency client 112 not only alerts a user to potential problems, it provides the user with information to help the user form a more cohesive teaching strategy embodied in the revised syllabus. For example, a user may not fully understand the dependencies of the learning objects in syllabus 302, and therefore may not understand the dependency violation without dependency client 112 automatically providing some information about the violation.

For example, a user activates a more information control 352 on warning window 350 of FIG. 3E. Warning window 350 may be displayed as: a pop-up window over a syllabus editing GUI; an independent GUI; a panel in a syllabus editing GUI, etc. According to an embodiment, in response to detecting activation of control 352, dependency service 122 provides the user with more information about any detected dependency violation.

To illustrate providing a user with more information in the context of the previous example, dependency service 122 sends information for the detected dependency violation to dependency client 112. In an embodiment, dependency client 112 displays the information about the dependency violation to the user in text form.

In another embodiment, dependency client 112 highlights, within a GUI that includes representations of the learning objects in syllabus 302 (such as GUI 320), those learning objects in the detected set of learning objects upon which learning object 312 depends. For example, to communicate dependency violation information, dependency client 112 highlights (with a distinctive font, font color, background color, icon, pointer indicator, etc.) learning object 330, since learning object 312 depends from learning object 330.

A warning message may also have information about fundamental concepts for learning object 312. In connection with such a warning message, dependency client 112 may also provide the user with information about the concepts associated with each learning object in syllabus 302. For example, dependency client 112 provides one or more controls that, when activated, show more information (including key terms) for one or more learning objects in syllabus 302. Such information may further include one or more of: information about what concepts should be taught in syllabus 302 (i.e., the core concepts of the syllabus), concepts that are assumed to be understood by students taking the course for syllabus 302, etc.

Further, a person editing a syllabus likely does not know about all of the learning objects in database 140, which the user could insert into a syllabus to correct a dependency violation. Specifically, there may be situations in which a user does not know of all of the learning objects that are available to fill a specific need. For example, in a situation where a user removes a learning object designed to teach a particular concept from a syllabus because the user did not like the way that the learning object was structured, or because the user did not think that the learning object was a good fit to teach the relevant students a particular concept, the user may not have knowledge of any learning objects in database 140 (other than the rejected learning object) that could help teach the needed concept. Thus, it would be useful for dependency service 122 to provide further information about learning objects 142 in connection with dependency violation warnings.

According to embodiments, learning object information that dependency client 112 provides to a user is not limited to information from learning objects in syllabus 302. According to embodiments, dependency client 112 provides information for learning objects from other disciplines, other courses, etc.

According to embodiments, upon detecting activation of control 352, dependency service 122 identifies learning objects from database 140 that, if inserted before learning object 312, would correct the dependency violation. To identify such learning objects, dependency service identifies one or more key terms on which learning object 312 depends, which are not associated with learning objects in list 322 located before the position of learning object 312. For example, dependency service 122 identifies the following key terms as representing fundamental concepts for learning object 312: “ratios”, “factors”, and “composites”. Dependency service 122 determines that learning object 334 (the only learning object located before learning object 312 in list 322) includes definitional uses of key terms “factors” and “composites” based on metadata for learning object 334. As such, dependency service 122 determines that the pertinent fundamental key term for learning object 312 is “ratios” because that key term is the only key term that is not defined in learning object 334. Dependency service 122 performs a search in learning objects 142 for learning objects that have a definitional use of the term “ratios”. Dependency client 112 displays, in a GUI (such as a pop up window over GUI 320) information identifying the learning objects in the results of the search.

According to an embodiment, a user has the option to request, from dependency client 112, information about learning objects that are configured to teach a particular concept that the user provides to dependency client 112. For example, a GUI provided by dependency client 112 includes a text box control into which a user may input one or more key terms. Based on the one or more key terms, dependency client 112 causes dependency service 122 to search learning objects 142 to identify learning objects that are associated with the one or more key terms. In this way, a user may utilize the system of network arrangement 100 to enrich a syllabus with learning objects designed to teach specific concepts selected by the user.

Dependency client 112 may allow a user to select which learning objects, represented in information provided by dependency client 112, that the user would like to insert into syllabus 302. In response to detecting activation of a control implementing such an option, dependency service 122 performs one or more of: automatically inserting the one or more selected learning objects into syllabus 302 (e.g., before learning object 312), providing the one or more selected learning objects in a panel with the GUI for editing syllabus 302 that allows the user to drag representations of the one or more selected learning objects into syllabus 302, etc.

Dependency client 112 may further provide information about the students taking the course for syllabus 302, e.g., proficiency levels of the students in fundamental concepts required by learning object 312. For example, dependency client 112 provides a control that, when activated, allows a user to view one or more reports on aspects of student profiles for students taking the course for syllabus 302. The user may indicate, to dependency client 112, what information to include in such reports.

Furthermore, dependency link metadata that indicates how a particular learning object depends from another learning object may be used by dependency service 122 to provide information to a user about dependency decisions. For example, the concept of negative numbers is introduced in a first learning activity associated with the topic Integers, and this learning objective is fundamental when describing the deviation from the mean which is a concept developed in a second learning activity within the topic Analyzing and Interpreting Data. In this example, a dependency link between the first learning activity (the fundamental learning object) and the second learning activity (the dependent learning object) is associated with link metadata indicating that the concept of negative numbers introduced in the fundamental object is developed in the dependent learning object.

### Automatically Correcting Dependency Violations

In addition to providing information about dependency violations and learning objects, dependency client 112 may also provide an option to automatically correct dependency violations in syllabus 302. For example, warning window 350 includes a correct syllabus control 354. In response to detecting activation of control 354, dependency client 112 causes dependency service 122 to automatically: identify a solution to the dependency violation, implement the solution, and provide information the correction for display to the user. According to one embodiment, if there are multiple dependency violations to remedy, dependency client 112 provides the user with a control that allows the user to identify one or more dependency violations for dependency service 122 to automatically correct.

According to embodiments, dependency service 122 identifies a minimum change to syllabus 302 required to automatically correct one or more identified dependency violations. A minimum change is one or more of: a change that requires the smallest number of learning objects to be inserted before a learning object that is the subject of a dependency violation (aka, a “violation learning object”); a change that represents the shortest amount of learning time (as described in further detail below) to be inserted before a violation learning object; a change that inserts the most focused learning objects before a violation learning object, where a focused learning object is configured to teach a fundamental concept of the violation learning object and is configured to teach the fewest non-fundamental concepts for the violation learning object; a change that uses the most learning objects already in the edited syllabus as possible; etc. A change that represents the shortest learning time is a change that, when implemented, adds the least total amount of estimated time to complete and/or present any learning objects that the change adds to the syllabus.

According to embodiments, database 140 includes heuristics that indicate priorities for one or more key terms (not shown in FIG. 1). For example, a first key term is indicated in the heuristics to be a high priority key term, and a second key term is indicated in the heuristics to be a low priority key term. A minimum change, formulated by dependency service 122, does not add, to a syllabus, a learning object that is associated with a low-priority key term as indicated in the heuristics stored in database 140. Furthermore, a minimum change does not add, to a syllabus, a learning object that is associated with a key term for which students of the syllabus have demonstrated at least a threshold level of understanding.

According to embodiments, dependency client 112 presents to the user, for user selection, one or more options for automatically correcting a syllabus that has one or more dependency violations. Dependency service 122 implements the solution that is selected by the user. Such representations include any amount of information about the learning objects that would be used to correct a dependency violation, such as title, component learning objects, key terms associated with the learning objects, etc.

According to further embodiments, dependency client 112 automatically provides a user with instructions on how to implement a minimum change to correct (or avoid) a dependency violation. For example, dependency client 112 visually indicates, to a user, the highest (aka earliest) position in the ordered list (e.g., list 322 of GUI 320) at which the learning object subject to the dependency violation (e.g., learning object 312) could be inserted into the list without causing any dependency violation. For example, dependency client 112 visually highlights a position within list 322 (i.e., immediately after learning object 330) as a position within syllabus 302 for learning object 312 that would not cause dependency violations. The visual highlight is accompanied by an implied or explicit suggestion to move learning object 312 to the indicated position. According to embodiments, dependency client 112 also visually highlights, within list 322, the one or more learning objects from which learning object 312 depends (i.e., learning object 330).

As a further illustration depicted in GUI 430 of FIG. 4D, dependency client 112 detects that a client has selected learning object 432 from the list of candidate objects 402. In response to detecting selection of learning object 432, dependency service 122 determines the highest (or earliest) position in syllabus list 404 at which learning object 432 may be placed without creating dependency violations (or creating the least number of dependency violations possible). In the example of GUI 430, dependency service 122 determines that the highest position that learning object 432 can be placed within list 404 is position 434. Dependency client 112 visually highlights this position using any method of highlighting, with the highlight of position 434 shown in GUI 430 being a non-limiting example.

### Time Estimations

One consideration in editing a syllabus is the amount of time it will take to teach or participate in the learning objects for the syllabus. A user may not know how much time each learning object takes to teach or complete, especially with respect to learning objects with which the user is not familiar (i.e., those learning objects that dependency service 122 automatically makes known to the user). As such, it would be useful for dependency client 112 to inform a user of an estimated or measured amount of time that learning objects take to complete and/or present. This information may be displayed in connection with a control, such as a “show more information” control or a “show estimated times” control in a graphical user interface.

Dependency service 122 may obtain information about estimated or measured amounts of time that learning objects take to complete and/or present from any number of sources. Herein, examples may be applied to both times to complete and times to present subject matter for a particular learning object, even when only one is mentioned. For example, dependency service 122 receives information from administrators, or from automatically detected data, indicating how much time, on average, students take to complete a particular learning object (e.g., from initial engagement with a learning object to completion of the learning object). As another example, an administrator may include an estimated amount of time for a learning object in metadata for the learning object. Furthermore, dependency service 122 may derive an estimated time to complete a composite learning object (that is composed of multiple learning objects, e.g., a chapter) based on estimated times to complete the component learning objects of the composite learning object.

Also, dependency client 112 may provide a user with the option of inputting amounts of time required to complete various learning objects. Dependency service 122 displays the input time information in response to future requests for time information from the user that provided the information. Further, dependency service 122 may use input information to automatically adjust estimated times for completing the learning objects such that the input information affects the estimated timing information provided to all users of the system. Furthermore, dependency service 122 may flag particular estimated timing information for review based on this user feedback. Taking user feedback into account allows the system to intelligently update timing estimates.

Displaying information about estimated times to complete or present a learning object may be especially helpful when dependency violations are detected. Estimated timing information may be presented to the user in connection with presented learning object information, including options for correcting dependency violations, which will give the user information about how inclusion of the various learning objects in the syllabus will affect the pacing and overall timing of the course.

Removal of a Learning Object from a Syllabus

Dependency service 122 also provides a user with information about the impact of removing learning objects from a syllabus. For example, removal of a learning object that is a fundamental learning object for other learning objects in the syllabus can cause one or more dependency violations. Furthermore, removal of particular learning objects removes, from a syllabus, one or more concepts that are required to be included in the syllabus (e.g., as indicated in the syllabus metadata). Dependency service 122 provides information about these situations in warning messages to the user in response to detecting removal of the learning objects from a syllabus. Furthermore, according to embodiments, dependency service 122 provides information to system administrators when learning objects that teach one or more core concepts for a course are removed from the course syllabus. Dependency service 122 may request information from the user about why the concept was removed from the course prior to sending the information to administrators.

In situations where a core or fundamental concept is taught by only a portion of a composite learning object, the user may choose to retain some component learning objects and remove others without removing the entire composite learning object. As such, dependency service 122 may provide information about removed learning objects, such as the content of particular component learning objects of the removed learning object. A user may choose to restore only those components of a removed learning object that are needed to retain core and/or fundamental concepts in the syllabus.

There may be instances in which an individual user should not remove certain learning objects from a syllabus for various reasons, i.e., the syllabus is used across multiple classes, one or more data integrity violations may occur, database 140 would be in an inconsistent state because of the removal, etc. Thus, according to embodiments, users must have permission to remove a learning object from a syllabus.

For example, dependency client 112 authenticates a user by any authentication method (such as username and password). Based on the authentication information, dependency service 122 retrieves permission data for the user. To illustrate, permission data comprises a role that the user has that inherently has permission to remove learning objects from any syllabus, or from a certain set of syllabi.

As another example, when dependency client 112 detects a command to remove a learning object from a particular syllabus, dependency service 122 automatically requests permission for the user to perform the removal. Furthermore, metadata for learning objects may indicate whether the object is removable, and/or whether a user needs to obtain permission to remove the object, etc. As such, dependency service 122 automatically requests permission for the user to perform removal of a learning object based on any applicable metadata for the learning object.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

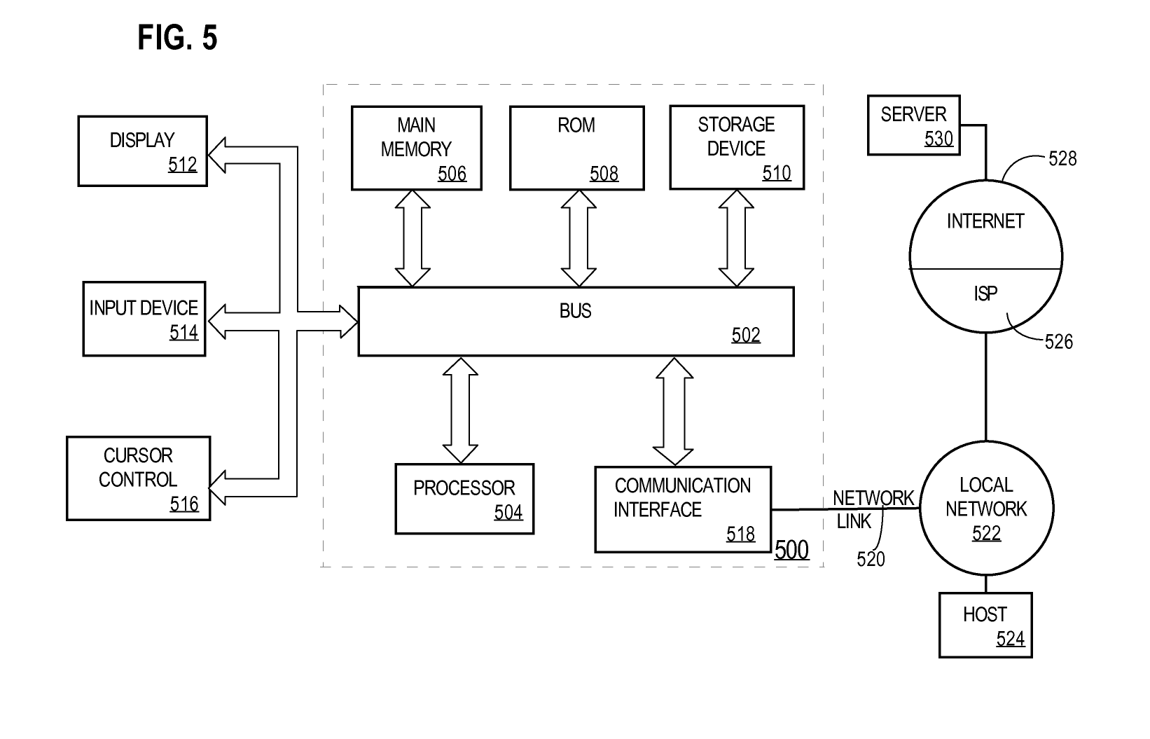

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
maintaining a dependency graph that indicates dependencies between learning objects of a plurality of learning objects;
in response to user input, creating a revised ordered list of learning objects by causing a particular learning object to be assigned to a particular position in a syllabus that contains an ordered list of zero or more other learning objects;
determining, based on the dependency graph, a set of learning objects upon which the particular learning object depends;
determining whether each learning object in the set of learning objects is present in the revised ordered list of learning objects before the particular position;
determining that a certain learning object in the set of learning objects is not present in the revised ordered list of learning objects before the particular position; and
in response to determining that the certain learning object in the set of learning objects is not present in the revised ordered list of learning objects before the particular position, generating an indication that the syllabus contains a dependency violation;
wherein the method is performed by one or more computing devices.

2. The method of claim 1, further comprising:
displaying, in a graphical user interface, a representation of each learning object in the revised ordered list;
displaying, in the graphical user interface, the indication that the syllabus contains a dependency violation;
identifying the certain learning object in the revised ordered list after the particular position; and
visually identifying a position subsequent to the representation of the certain learning object in the display of the revised ordered list.

3. The method of claim 1, further comprising:
displaying, in a graphical user interface, the indication that the syllabus contains a dependency violation;
including, in the graphical user interface, a learning object information control;
detecting activation of the learning object information control;
in response to detecting activation of the learning object information control:
identifying one or more concepts, on which the particular learning object is dependent, that are not taught by learning objects in the revised ordered list before the particular position,
identifying one or more learning objects, from a repository of learning objects, that teach the one or more concepts, and
displaying, in the graphical user interface, information identifying the one or more learning objects.

4. The method of claim 1, further comprising:
displaying, in a graphical user interface, the indication that the syllabus contains a dependency violation; and
including, in the graphical user interface, information about the dependency violation.

5. The method of claim 1, further comprising:
displaying, in a graphical user interface, a representation of each learning object in the revised ordered list;
displaying, in the graphical user interface, the indication that the syllabus contains a dependency violation;
including, in the graphical user interface, a dependency correction control;
detecting activation of the dependency correction control;
wherein determining that the certain learning object in the set of learning objects is not present in the revised ordered list of learning objects before the particular position comprises identifying a dependency violation;
in response to detecting activation of the dependency correction control:
automatically identifying a minimum change, to make to the revised ordered list, that remedies the dependency violation, and
creating a second revised ordered list by automatically performing the minimum change to the revised ordered list.

6. The method of claim 1, wherein automatically identifying a minimum change to make to the revised ordered list to remedy the dependency violation comprises identifying one or more of:
a change that requires the smallest number of learning objects to be inserted before the particular learning object;
a change that represents the shortest amount of learning time to be inserted before the particular learning object;
a change that inserts the most focused learning objects before a violation learning object, wherein a focused learning object is configured to teach a fundamental concept of the particular learning object and is configured to teach the fewest non-fundamental concepts for the particular learning object; or
a change that uses the most learning objects already in the revised ordered list as possible.

7. The method of claim 1, wherein determining the set of learning objects upon which the particular learning object depends comprises:
identifying a plurality of learning objects, wherein each of two or more learning objects of the plurality of learning objects independently teaches a particular concept;
wherein the particular concept is a fundamental concept for the particular learning object;
receiving user input selecting a first learning object of the two or more learning objects; and
in response to receiving the user input, including the first learning object in the set of learning objects and excluding a second learning object from the set of learning objects.

8. The method of claim 1, further comprising:
identifying a first learning object, of the plurality of learning objects, that includes a definitional use of a particular key term;
identifying a second learning object, of the plurality of learning objects, that includes a non-definitional use of the particular key term;
in response to identifying the second learning object that includes the non-definitional use of the particular key term, establishing a dependency link, in the dependency graph, between the first and second learning objects.

9. The method of claim 1, further comprising:
identifying a particular reference, in metadata for the particular learning object, to a particular standardized key term in a standardized hierarchy;
identifying one or more fundamental standardized key terms on which the particular standardized key term depends based on one or more dependency links in the standardized hierarchy;
identifying a second learning object, of the plurality of learning objects, that is associated with the one or more fundamental standardized key terms in metadata for the second learning object; and
in response to identifying the second learning object, establishing a dependency link, in the dependency graph, between the particular and second learning objects.

10. One or more computer-readable media storing instructions which, when executed by one or more processors, causes execution of the steps of:
maintaining a dependency graph that indicates dependencies between learning objects of a plurality of learning objects;
in response to user input, creating a revised ordered list of learning objects by causing a particular learning object to be assigned to a particular position in a syllabus that contains an ordered list of zero or more other learning objects;
determining, based on the dependency graph, a set of learning objects upon which the particular learning object depends;
determining whether each learning object in the set of learning objects is present in the revised ordered list of learning objects before the particular position;
determining that a certain learning object in the set of learning objects is not present in the revised ordered list of learning objects before the particular position; and
in response to determining that the certain learning object in the set of learning objects is not present in the revised ordered list of learning objects before the particular position, generating an indication that the syllabus contains a dependency violation.

11. The one or more computer-readable media of claim 10, the instructions further comprising instructions for:
displaying, in a graphical user interface, a representation of each learning object in the revised ordered list;
displaying, in the graphical user interface, the indication that the syllabus contains a dependency violation;
identifying the certain learning object in the revised ordered list after the particular position; and
visually identifying a position subsequent to the representation of the certain learning object in the display of the revised ordered list.

12. The one or more computer-readable media of claim 10, the instructions further comprising instructions for:
displaying, in a graphical user interface, the indication that the syllabus contains a dependency violation;
including, in the graphical user interface, a learning object information control;
detecting activation of the learning object information control;
in response to detecting activation of the learning object information control:
identifying one or more concepts, on which the particular learning object is dependent, that are not taught by learning objects in the revised ordered list before the particular position,
identifying one or more learning objects, from a repository of learning objects, that teach the one or more concepts, and
displaying, in the graphical user interface, information identifying the one or more learning objects.

13. The one or more computer-readable media of claim 10, the instructions further comprising instructions for:
displaying, in a graphical user interface, the indication that the syllabus contains a dependency violation; and
including, in the graphical user interface, information about the dependency violation.

14. The one or more computer-readable media of claim 10, the instructions further comprising instructions for:
displaying, in a graphical user interface, a representation of each learning object in the revised ordered list;
displaying, in the graphical user interface, the indication that the syllabus contains a dependency violation;
including, in the graphical user interface, a dependency correction control;
detecting activation of the dependency correction control;
wherein determining that the certain learning object in the set of learning objects is not present in the revised ordered list of learning objects before the particular position comprises identifying a dependency violation;
in response to detecting activation of the dependency correction control:
automatically identifying a minimum change, to make to the revised ordered list, that remedies the dependency violation, and
creating a second revised ordered list by automatically performing the minimum change to the revised ordered list.

15. The one or more computer-readable media of claim 10, wherein automatically identifying a minimum change to make to the revised ordered list to remedy the dependency violation comprises identifying one or more of:
a change that requires the smallest number of learning objects to be inserted before the particular learning object;
a change that represents the shortest amount of learning time to be inserted before the particular learning object;
a change that inserts the most focused learning objects before a violation learning object, wherein a focused learning object is configured to teach a fundamental concept of the particular learning object and is configured to teach the fewest non-fundamental concepts for the particular learning object; or
a change that uses the most learning objects already in the revised ordered list as possible.

16. The one or more computer-readable media of claim 10, wherein determining the set of learning objects upon which the particular learning object depends comprises:
identifying a plurality of learning objects, wherein each of two or more learning objects of the plurality of learning objects independently teaches a particular concept;
wherein the particular concept is a fundamental concept for the particular learning object;
receiving user input selecting a first learning object of the two or more learning objects; and
in response to receiving the user input, including the first learning object in the set of learning objects and excluding a second learning object from the set of learning objects.

17. The one or more computer-readable media of claim 10, the instructions further comprising instructions for:
identifying a first learning object, of the plurality of learning objects, that includes a definitional use of a particular key term;
identifying a second learning object, of the plurality of learning objects, that includes a non-definitional use of the particular key term;
in response to identifying the second learning object that includes the non-definitional use of the particular key term, establishing a dependency link, in the dependency graph, between the first and second learning objects.

18. The one or more computer-readable media of claim 10, the instructions further comprising instructions for:
identifying a particular reference, in metadata for the particular learning object, to a particular standardized key term in a standardized hierarchy;
identifying one or more fundamental standardized key terms on which the particular standardized key term depends based on one or more dependency links in the standardized hierarchy;
identifying a second learning object, of the plurality of learning objects, that is associated with the one or more fundamental standardized key terms in metadata for the second learning object; and
in response to identifying the second learning object, establishing a dependency link, in the dependency graph, between the particular and second learning objects.
